(19) United States
(12) Patent Application Publication
(10) Pub. No.: US 2022/0405712 A1
(43) Pub. Date: Dec. 22, 2022

(54) Autonomous Request Management

(71) Applicant: ADP, LLC, Roseland, NJ (US)

(72) Inventors: Dipak Sarma, Hyderabad (IN); Ian King, Petersborough (GB); Sachin Havaldar, Chertsey (GB); Savitri Katam, Hyderabad (IN); Pawan Gubbala, Hyderabad (IN); Bhavani Meegada, Hyderabad (IN); Monika Nagalla, Hyderabad (IN); Sharad Akundi, Hyderabad (IN); Sriram Patalay, Hyderabad (IN); S R Kirshnaraju Vysayara, Hyderabad (IN); Golla Srinidhi, Roseland, NJ (US)

(21) Appl. No.: 17/304,491

(22) Filed: Jun. 22, 2021

(51) Int. Cl. G06Q 10/10; G06Q 40/00; G06N 5/02

(52) U.S. Cl. CPC G06Q 10/1091; G06Q 10/105; G06Q 40/125; G06N 5/025

(57) ABSTRACT

A method, apparatus, system, and computer program code for autonomous management of request-for-approvals within an organization. The computer system receives a request-for-approval submitted by an employee of the organization. The computer system determines whether a set of rules has been configured for autonomously managing a human capital operation associated with the request-for-approval. Responsive to determining that the set of rules has been configured, the computer system determines whether a set of parameters for applying a particular rule has been met. Responsive to determining that the set of parameters for the particular rule has been met, the computer system applies the particular rule to determine an outcome. The computer system determines whether outcomes are consistent for each rule of the set of rules that was applied. Responsive to determining that the outcomes are consistent, the computer system autonomously performs the human capital operation according to the outcomes. Responsive to performing the human capital operation, the computer system transmits a confirmation of the human capital operation to an employee-manager.

### BACKGROUND

### 1. Field

The disclosure relates generally to an improved computer system and, more specifically, to a method, apparatus, computer system, and computer program product for autonomous management of request-for-approvals within an organization.

### 2. Description of the Related Art

An “enterprise” is a plurality of physical computers that communicate with each other at least indirectly and which, as a whole, are configured to cooperate together to accomplish one or more tasks. An “enterprise environment” is all of the physical hardware that allows the enterprise to operate, including wired and wireless communications devices and other equipment such as but not limited to printer, scanners, input devices, monitors, and other hardware components.

When an enterprise environment becomes large and sophisticated, communication among computers can become problematic. This communication problem evidences itself when certain tasks are desired to be performed by an organization that maintains the enterprise environment.

For example, an organization may require approvals for certain business activities, such as but not limited to the expenditure of money. Within the context of a human capital management system, the volume of requests submitted for approval can be very high. Any of these requests are sent to a manager of employees for approval, which means the manager needs to spend time reviewing and responding to each request. For example, if a weekly timesheet that is filled out by employees needs approval, the approver will have to spend some time going through each of these timesheets to manually approve or reject the submission. Similarly, in the case of a time-off request, the approver may need to reference other factors, such as team coverage during the requested time-off duration and the employee's available/accrued time-off, before approving the request. Reviewing and responding to each of these requests detracts from time that managers are able to spend on strategic tasks and operations of the organization

Furthermore, the illustrative embodiments recognize and take into account that, from an employee's point of view, approval of requests often take more time than is desirable. Often, the employee needs to wait for approval before they can proceed with subsequent activities related to the request. For example, in case of a holiday time off request, the employee may need to wait for approval before they can finalize plans and arrangements. Any delay in approval of the request can result in a poor experience for the employee who submitted the request.

Accordingly, the overall efficiency and performance of both the enterprise itself and the organization operating the enterprise can be affected in an undesirable manner.

### SUMMARY

According to one embodiment of the present invention, a computer-implemented method provides for autonomous management of request-for-approvals within an organization. A computer system receives a request-for-approval submitted by an employee of the organization. The computer system determines whether a set of rules has been configured for autonomously managing a human capital operation associated with the request-for-approval. Responsive to determining that the set of rules has been configured, the computer system determines whether a set of parameters for applying a particular rule has been met. Responsive to determining that the set of parameters for the particular rule has been met, the computer system applies the particular rule to determine an outcome. The computer system determines whether outcomes are consistent for each rule of the set of rules that was applied. Responsive to determining that the outcomes are consistent, the computer system autonomously manages the human capital operation according to the outcomes. Responsive to performing the human capital operation, the computer system transmits a confirmation of the human capital operation to an employee-manager.

According to another embodiment of the present invention, a request management system is provided for autonomous management of request-for-approvals within an organization. The request management system comprises a computer system and a request manager within the computer system. The request manager is configured to receive a request-for-approval submitted by an employee of the organization. The request manager is configured to determine whether a set of rules has been configured for autonomously managing a human capital operation associated with the request-for-approval. The request manager is configured to determine a set of parameters for applying a particular rule has been met in response to determining that the set of rules has been configured. The request manager is configured to apply the particular rule to determine an outcome in response to determining that the set of parameters for the particular rule has been met. The request manager is configured to determine whether outcomes are consistent for each rule of the set of rules that was applied. The request manager is configured to autonomously perform the human capital operation according to the outcomes responsive to determining that the outcomes are consistent. The request manager is configured to transmit a confirmation of the human capital operation to an employee-manager in response to performing the human capital operation.

According to yet another embodiment of the present invention, a computer program product for autonomous management of request-for-approvals within an organization. The computer program product comprises a computer-readable storage media with program code stored on the computer-readable storage media. The program code is executable by a computer system to receive a request-for-approval submitted by an employee of the organization; to determine whether a set of rules has been configured for autonomously managing a human capital operation associated with the request-for-approval; responsive to determining that the set of rules has been configured, to determine a set of parameters for applying a particular rule has been met; responsive to determining that the set of parameters for the particular rule has been met, to apply the particular rule to determine an outcome; to determine whether outcomes are consistent for each rule of the set of rules that was applied; responsive to determining that the outcomes are consistent, to autonomously perform the human capital operation according to the outcomes; and responsive to performing the human capital operation, to transmit a confirmation of the human capital operation to an employee-manager.

### BRIEF DESCRIPTION OF THE DRAWINGS

FIG. 1 is a pictorial representation of a network of data processing systems in which illustrative embodiments may be implemented;

FIG. 2 is a block diagram of a request management environment in accordance with an illustrative embodiment;

FIG. 3 is a high-level flowchart of a process for autonomous management of requests in accordance with an illustrative embodiment;

FIG. 4 is a flowchart of a process for autonomous management of request-for-approvals within an organization in accordance with an illustrative embodiment;

FIG. 5 is a flowchart of a process for autonomous management of request-for-approvals with inconsistent rule outcomes in accordance with an illustrative embodiment;

FIG. 6 is a flowchart of a process for autonomous management of request-for-approvals with unconfigured rules in accordance with an illustrative embodiment;

FIG. 7 is a flowchart of a process for generating rules for autonomous management of request-for-approvals in accordance with an illustrative embodiment;

FIG. 8 is a flowchart of a process for autonomous management of request-for-approvals according to generated rules in accordance with an illustrative embodiment; and

FIG. 9 is a block diagram of a data processing system in accordance with an illustrative embodiment.

### DETAILED DESCRIPTION

The illustrative embodiments recognize and take into account one or more different considerations. For example, the illustrative embodiments recognize and take into account that, within the context of a human capital management system, the volume of requests submitted for approval can be very high. Any of these requests are sent to a manager of employees for approval, which means the manager needs to spend time reviewing and responding to each request. For example, if a weekly timesheet that is filled out by employees needs approval, the approver will have to spend some time going through each of these timesheets to manually approve or reject the submission. Similarly, in the case of a time-off request, the approver may need to reference other factors, such as team coverage during the requested time-off duration and the employee's available/accrued time-off, before approving the request. Reviewing and responding to each of these requests detracts from time that managers are able to spend on strategic tasks and operations of the organization

Furthermore, the illustrative embodiments recognize and take into account that, from an employee's point of view, approval of requests often take more time than is desirable. Often, the employee needs to wait for approval before they can proceed with subsequent activities related to the request. For example, in case of a holiday time off request, the employee may need to wait for approval before they can finalize plans and arrangements. Any delay in approval of the request can result in a poor experience for the employee who submitted the request.

Thus, the illustrative embodiments recognize and take into account that it would be desirable to have a method, apparatus, computer system, and computer program product that takes into account the issues discussed above as well as other possible issues. For example, it would be desirable to have a method, apparatus, computer system, and computer program product that provides for automated approval of requests, as well as capabilities for autonomously configuring rule sets for the approval of requests.

In one illustrative example, a computer system provides a computer-implemented method for autonomous management of request-for-approvals within an organization. The computer system receives a request-for-approval submitted by an employee of the organization. The computer system determines whether a set of rules has been configured for autonomously managing a human capital operation associated with the request-for-approval. Responsive to determining that the set of rules has been configured, the computer system determines whether a set of parameters for applying a particular rule has been met. Responsive to determining that the set of parameters for the particular rule has been met, the computer system applies the particular rule to determine an outcome. The computer system determines whether outcomes are consistent for each rule of the set of rules that was applied. Responsive to determining that the outcomes are consistent, the computer system autonomously performs the human capital operation according to the outcomes. Responsive to performing the human capital operation, the computer system transmits a confirmation of the human capital operation to an employee-manager.

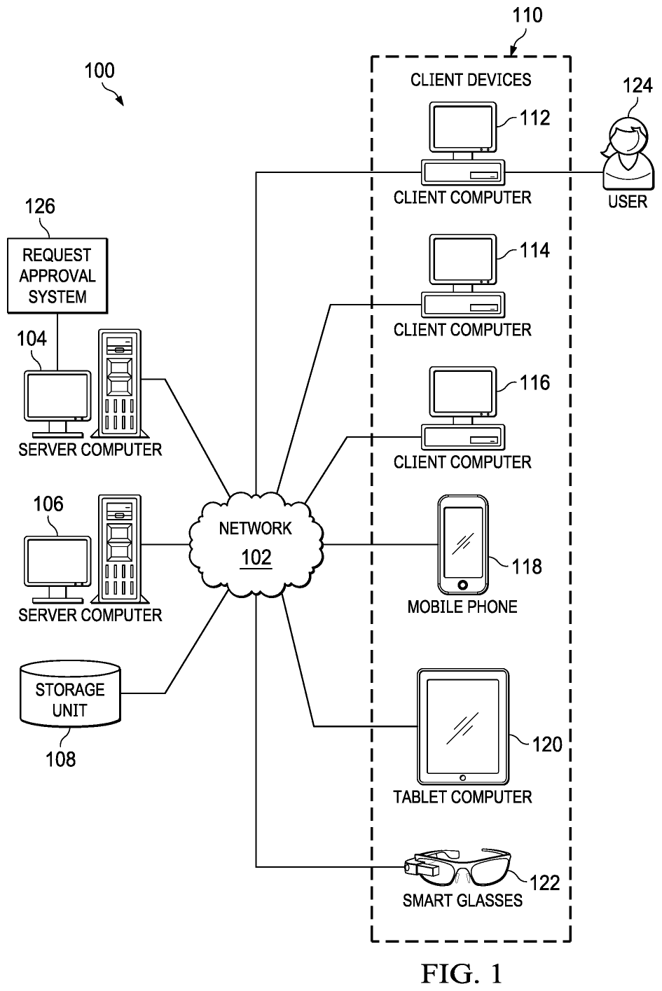

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. As depicted, client devices 110 include client computer 112, client computer 114, and client computer 116. Client devices 110 can be, for example, computers, workstations, or network computers. In the depicted example, server computer 104 provides information, such as boot files, operating system images, and applications to client devices 110. Further, client devices 110 can also include other types of client devices such as mobile phone 118, tablet computer 120, and smart glasses 122. In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage media and downloaded to a data processing system or other device for use. For example, the program code can be stored on a computer-recordable storage media on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

As used herein, a “number of,” when used with reference to items, means one or more items. For example, a “number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

In the illustrative example, user 124 operates client computer 112. User 124 can submit request for approvals to request management system 202. In the illustrative example, request management system 202 can provide autonomous management of request-for-approvals in response to receiving user input 218 from user 124 requesting approval of requests.

In this illustrative example, request management system 202 can be run in a remote location such as on server computer 104. In another illustrative example, request management system 202 can run on client computer 112 and can take the form of a system instance of the application. In yet other illustrative examples, request management system 202 can be distributed in multiple locations within network data processing system 100. For example, request management system 202 can run on client computer 112 and on client computer 114 or on client computer 112 and server computer 104 depending on the particular implementation.

request management system 202 can operate to provide automated approval of requests based on tolerances and rule sets defined within request management system 202. For example, in the context of human capital management, the automated approval of requests can include time off request, timesheet submissions, and expense approvals. request management system 202 provides capabilities for autonomous configuring of new rule sets, as well as recommending these new rule sets based on historical data and prior approval patterns of different requests by user 124

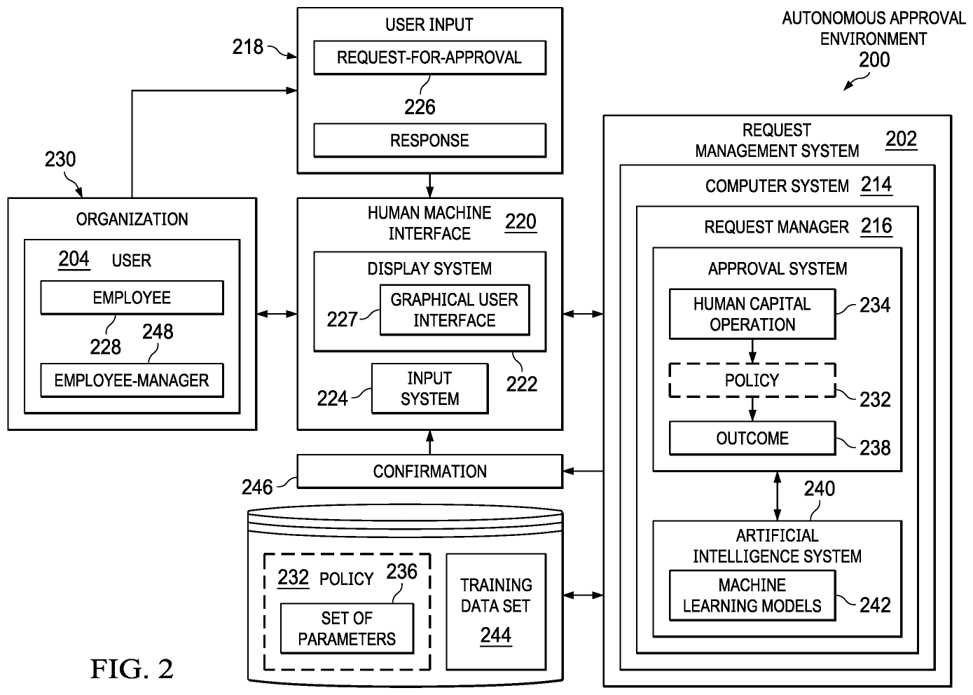

With reference now to FIG. 2, a block diagram of an application environment is depicted in accordance with an illustrative embodiment. In this illustrative example, autonomous approval environment 200 includes components that can be implemented in hardware such as the hardware shown in network data processing system 100 in FIG. 1.

Request management system 202 is an example of request approval system 126 of FIG. 1. In this illustrative example, request management system 202 in autonomous approval environment 200 can provide autonomous management of request-for-approvals.

As depicted, request management system 202 comprises computer system 214 and request manager 216. request manager 216 runs in computer system 214. request manager 216 can be implemented in software, hardware, firmware, or a combination thereof. When software is used, the operations performed by request manager 216 can be implemented in program code configured to run on hardware, such as a processor unit. When firmware is used, the operations performed by request manager 216 can be implemented in program code and data and stored in persistent memory to run on a processor unit. When hardware is employed, the hardware may include circuits that operate to perform the operations in request manager 216.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 214 is a physical hardware system and includes one or more data processing systems. When more than one data processing system is present in computer system 214, those data processing systems are in communication with each other using a communications medium. The communications medium can be a network. The data processing systems can be selected from at least one of a computer, a server computer, a tablet computer, or some other suitable data processing system.

As depicted, human machine interface 220 comprises display system 222 and input system 224. Display system 222 is a physical hardware system and includes one or more display devices on which graphical user interface 227 can be displayed. The display devices can include at least one of a light emitting diode (LED) display, a liquid crystal display (LCD), an organic light emitting diode (OLED) display, a computer monitor, a projector, a flat panel display, a heads-up display (HUD), or some other suitable device that can output information for the visual presentation of information.

User 204 is a person that can interact with graphical user interface 227 through user input 218 generated by input system 224 for computer system 214. Input system 224 is a physical hardware system and can be selected from at least one of a mouse, a keyboard, a trackball, a touchscreen, a stylus, a motion sensing input device, a gesture detection device, a cyber glove, or some other suitable type of input device.

In this illustrative example, human machine interface 220 can enable user 204 to interact with one or more computers or other types of computing devices in computer system 214. For example, these computing devices can be client devices such as client devices 110 in FIG. 1.

In this illustrative example, request manager 216 in computer system 214 is configured to receive a request-for-approval 226 submitted by an employee 228 of the organization 230. Request manager 216 determines whether a policy 232 has been configured for autonomously managing a human capital operation 234 associated with the request-for-approval 226.

If the system approves or rejects a request, a notification can be sent to the approver and requester informing them of the outcome. The approver can look at the history of automatic approvals and can then find out which rules caused an automatic response

In this illustrative example, request manager 216 can autonomously manage human capital operation 234 using policy 232. Policy 232 is a set of rules and can include data used to apply the set of rules. request manager 216 determines outcome 238 according to policy 232, and can perform the human capital operation 234 according to the determined outcome 238.

In this illustrative example, each policy 232 defines one or more rules. For example, policy 232 may define rule conditions for using the parameters. Multiple conditions can be added within a rule. In one illustrative example, one or more rules can be excluded when all of the conditions defined in the rule are met; one or more rules can be applied when all of the conditions defined in the rule are met.

In this illustrative example, policy 232 may define an outcome of the rule. For example, one or more rules may specify conditions for rejecting the request-for-approval 226. one or more rules may specify conditions for approving the request-for-approval 226.

In an illustrative example, request management system 202 supports applying different sets of rules to different sets of employees. In this illustrative example, policy 232 may define additional options to specify when the rule is applicable and to whom the rule is applicable. For example, one or more rules may be applied only during a certain time period of the year. In another example, a different set of rules may be applied for different jobs, departments, locations within an organization.

In one illustrative example, the human capital operation 234 is selected from the group consisting of an approval of a time-off request, an approval of a timesheet, an approval of an expense, and combinations thereof.

In an illustrative example, in response to determining that the set of rules has been configured, request manager 216 determines whether a set of parameters 236 for applying a particular rule has been met. request manager 216 applies the particular rule to determine an outcome 238 in response to determining that the set of parameters for the particular rule has been met.

In one illustrative example, the set of parameters in policy 232 is selected from the group consisting of a classification of employees to whom the rule applies, a time period in which the rule applies, and combinations thereof. request manager 216 performs the human capital operation 234 according to the determined outcome 238 of policy 232.

In one illustrative example the human capital operation is the time-off request. When human capital operation is the time-off request, the set of parameters can include additional parameters selected from the group consisting of team availability during the time-off period, duration of the time-off, a type of the time-off request, a nature of the time-off request, a projected workload during the time-off request, and combinations thereof.

In one illustrative example the human capital operation is the approval of a timesheet. When human capital operation is the approval of a timesheet, the, the set of parameters can include additional parameters selected from the group consisting of total number of hours in the timesheet, total number of overtime hours in the timesheet, a historical variance of hours in the timesheet, a submission timeliness of the timesheet, and combinations thereof.

In one illustrative example the human capital operation is the approval of an expense. When the human capital operation is the approval of the expense, the set of parameters can include additional parameters selected from the group consisting of an amount of the expense, a type of the expense, a documentation of the expense, and combinations thereof.

Policy 232 can include multiple rules for determining the outcome of a request for approval. When the policy contains multiple rules, the request can be approved or denied based on the consistency of the outcomes of those rules. For example, if the conditions are met for one or more rules where the outcome is approved, then the request is an approval of the request. If the conditions are met for one or more rules where the outcome is the rejection of the request, then the request is approved. If the conditions are not met for any rules, then the request can be forwarded to the employee manager for manual approval. If the conditions are met for multiple rules, but the outcome is inconsistent for the rules, then the request can be forwarded to the manager employee for manual approval.

In one illustrative example, if the system approves or rejects a request, a notification can be sent to the approver and requester informing them of the outcome. The approver can look at the history of automatic approvals and can then find out which rules caused an automatic response

In an illustrative example, Request manager 216 determines whether outcomes 238 are consistent for each rule of policy 232 that was applied. responsive to determining that the outcomes are consistent, request manager 216 autonomously performs the human capital operation 234 according to the outcomes 238. responsive to performing the human capital operation 234, request manager 216 transmits a confirmation 246 of the human capital operation 234 to an employee-manager 248.

When an inconsistent outcome requires manual approval from an employee manager, request manager 216 performs the human capital operation according to the response received from the employee manager. In an illustrative example with inconsistent rule outcomes, responsive to determining that the outcomes are not consistent, request manager 216 forwards the request-for-approval to the employee-manager; request manager 216 receives a response from the employee-manager; request manager 216 performs the human capital operation according to the response.

When a set of rules autonomously managing a particular request have not been configured, request manager 216 performs the human capital operation according to the response received from the employee manager. In an illustrative example with unconfigured rules, responsive to determining that the set of rules has not been configured, request manager 216 forwards the request-for-approval to the employee-manager; request manager 216 receives a response from the employee-manager; request manager 216 performs the human capital operation according to the response.

In some illustrative examples, request manager 216 uses artificial intelligence system 240. Artificial intelligence system 240 is a system that has intelligent behavior and can be based on the function of a human brain. An artificial intelligence system comprises at least one of an artificial neural network, a cognitive system, a Bayesian network, a fuzzy logic, an expert system, a natural language system, or some other suitable system. Machine learning is used to train the artificial intelligence system. Machine learning involves inputting data to the process and allowing the process to adjust and improve the function of the artificial intelligence system.

In this illustrative example, artificial intelligence system 240 can include a set of machine learning models 242. A machine learning model is a type of artificial intelligence model that can learn without being explicitly programmed. A machine learning model can learn based on training data input into the machine learning model. The machine learning model can learn using various types of machine learning algorithms. The machine learning algorithms include at least one of a supervised learning, an unsupervised learning, a feature learning, a sparse dictionary learning, and anomaly detection, association rules, or other types of learning algorithms. Examples of machine learning models include an artificial neural network, a decision tree, a support vector machine, a Bayesian network, a genetic algorithm, and other types of models. These machine learning models can be trained using data and process additional data to provide a desired output.

In this illustrative example, Request manager 216 creating a training data set from the response. The set of machine learning models 242 is trained from training data set 244. Based on the training data set, Artificial intelligence system 240 builds a set of predictive models for generating a new set of parameters;

Using the machine learning algorithms, different patterns within the data sets can be recognized. For example, after clustering the data and looking at two types of pattern recognition methods of classification without learning; and classification with learning.

Based on historical data and subsequent analysis, there are 2 ways in which a new rule set can be defined. For example, Once trained, machine learning models 242 enables request management system 202 to generate a new set of rules which will build in the required tolerances for the system to make appropriate decisions and take corresponding actions. Furthermore, machine learning models 242 enables request management system 202 to make recommendations for a set of new rules by employing a behavior analysis of different rule sets created by employee-manager and looking at historical data in the system using classification with learning techniques.

For example, using set of machine learning models 242 trained with training data set ABC, request manager 216 generates a new rule according to the new set of parameters. Request manager 216 can then recommending the new rule to the employee-manager.

In one illustrative example, Request manager 216 receives a response from the employee-manager. When the response is an approval of the new rule, the new rule can be stored as one of set of policy 232. Request manager 216 can autonomously manage subsequent request-for-approvals according to the new rule.

Computer system 214 can be configured to perform at least one of the steps, operations, or actions described in the different illustrative examples using software, hardware, firmware, or a combination thereof. As a result, computer system 214 operates as a special purpose computer system when request manager 216 is included in computer system 214. In particular, request manager 216 transforms computer system 214 into a special purpose computer system as compared to currently available general computer systems that do not have request manager 216. In this example, computer system 214 operates as a tool that can increase at least one of speed, accuracy, or usability of computer system 214.

The illustration of autonomous approval environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. The illustrations of autonomous approval environment 200 in FIG. 2 is provided as one illustrative example of an implementation for autonomously managing request-for-approvals and are not meant to limit the manner in which the approvals can be generated and presented in other illustrative examples.

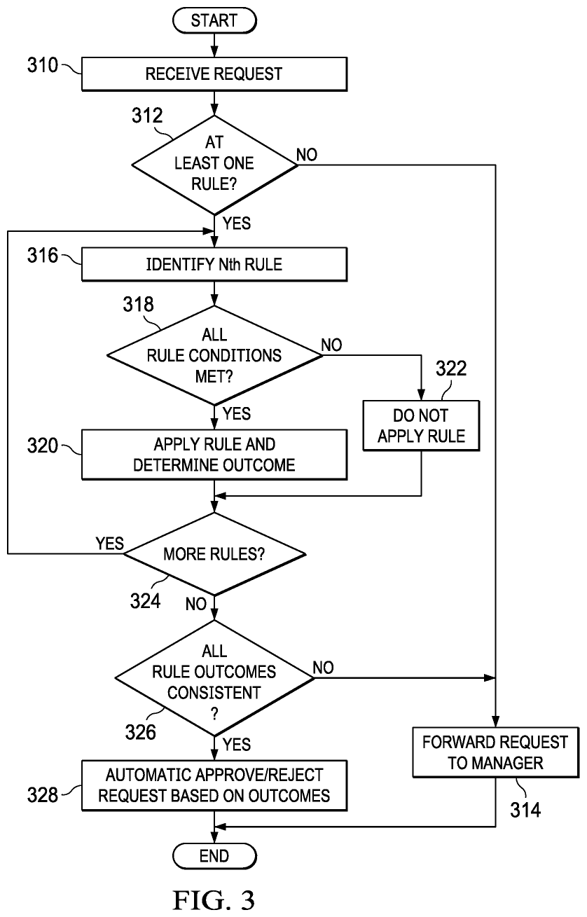

Turning next to FIG. 3, a high-level flowchart of and autonomous approval process is depicted in accordance with an illustrative embodiment. The process in FIG. 3 can be implemented in hardware, software, or both. When implemented in software, the process can take the form of program code that is run by one or more processor units located in one or more hardware devices in one or more computer systems. For example, the process can be implemented in request manager 216 in computer system 214 in FIG. 2.

The process begins by receiving a request for approval (step 310). The process then determines whether at least one rule has been configured for autonomously managing the request (step 312). If at least one rule has not been configured (“no” at step 312), the process forwards the request to an manager employee for manual approval (step 314), and terminates thereafter.

Returning asked to step 312, if at least one rule has been configured (“yes” at step 312), the process identifies an Nth rule (step 316), and determines if all rule conditions have been met for applying the rule (step 318). If all conditions for applying the rule have been met (“yes” at 318), the process applies the rule and determines an outcome based on the application of the rule (step 320). Alternatively, If all conditions for applying the rule have not been met (“no” at 318), the process does not apply the rule (step 322).

The process then determines whether there are additional rules (step 324). If there are additional rules, the process iterates back to step 316.

When all rules within the policy have been processed, and there are no additional rules (“no” at step 324), the process determines whether the outcomes of all applied rules that are consistent (step 326). If all rule outcomes are consistent, the process automatically approves or rejects the request based on the consistent outcomes of the rules (step 328). If the rule outcomes are inconsistent, the process forwards the request to an employee manager for manual approval (step 314). The process terminates thereafter.

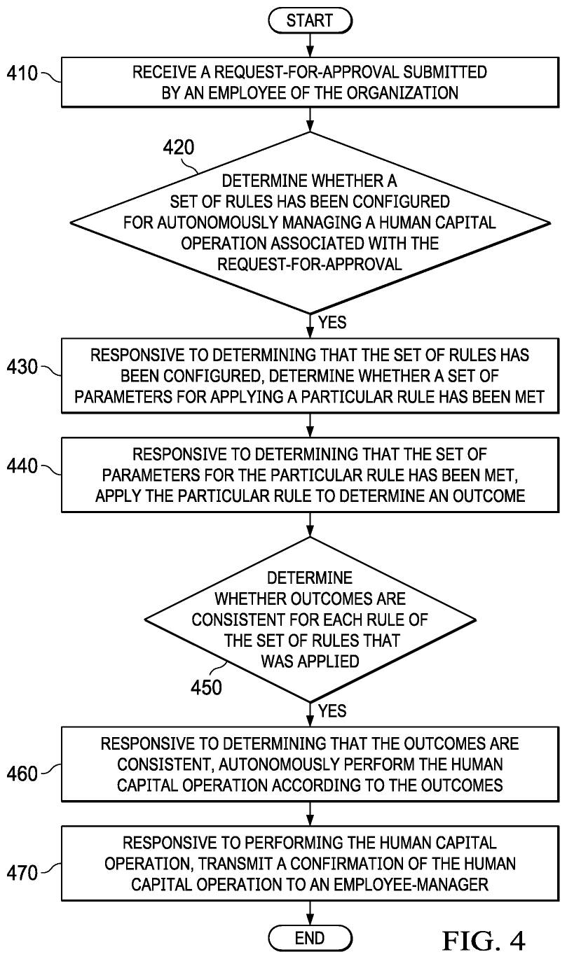

With reference next to FIG. 4, a flowchart of a process for autonomously managing request for approvals within an organization is depicted in accordance with an illustrative embodiment. The process in FIG. 4 can be implemented in hardware, software, or both. When implemented in software, the process can take the form of program code that is run by one or more processor units located in one or more hardware devices in one or more computer systems. For example, the process can be implemented in request manager 216 in computer system 214 in FIG. 2.

The process receives a request-for-approval submitted by an employee of the organization (step 410). The process determines whether a set of rules has been configured for autonomously managing a human capital operation associated with the request-for-approval (step 420). In one illustrative example, the human capital operation can be selected from the group consisting of an approval of a time-off request, an approval of a timesheet, an approval of an expense, and combinations thereof.

Responsive to determining that the set of rules has been configured, the process determines whether a set of parameters for applying a particular rule has been met (step 430). In one illustrative example, the set of parameters is selected from the group consisting of a classification of employees to whom the rule applies, a time period in which the rule applies, and combinations thereof.

When the human capital operation is the time-off request, the set of parameters can include additional parameters selected from the group consisting of team availability during the time-off period, duration of the time-off, a type of the time-off request, a nature of the time-off request, a projected workload during the time-off request, and combinations thereof.

When the human capital operation is the approval of the timesheet, the set of parameters includes additional parameters selected from the group consisting of total number of hours in the timesheet, total number of overtime hours in the timesheet, a historical variance of hours in the timesheet, a submission timeliness of the timesheet, and combinations thereof.

When the human capital operation is the approval of the expense, the set of parameters includes additional parameters selected from the group consisting of an amount of the expense, a type of the expense, a documentation of the expense, and combinations thereof.

responsive to determining that the set of parameters for the particular rule has been met, the process applies the particular rule to determine an outcome (step 440). The process determines whether outcomes are consistent for each rule of the set of rules that was applied (step 450).

responsive to determining that the outcomes are consistent the process autonomously performs the human capital operation according to the outcomes (step 460). responsive to performing the human capital operation, the process transmits a confirmation of the human capital operation to an employee-manager (step 470), and terminates thereafter.

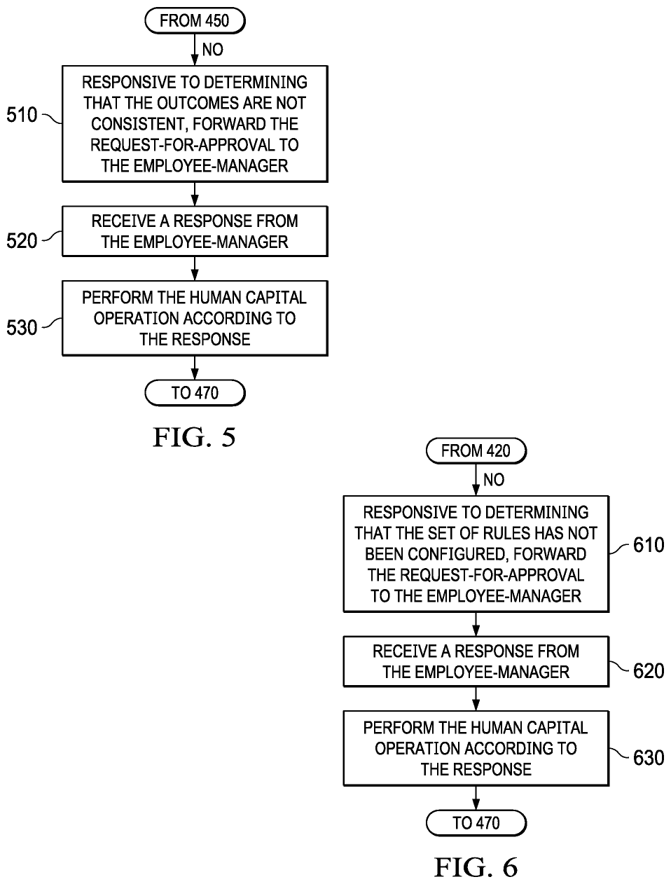

With reference next to FIG. 5, a flowchart of a process for performing the human capital operation according to inconsistent rule outcomes is depicted in accordance with an illustrative embodiment. The process in FIG. 5 can be implemented as an alternative to process step 460 of FIG. 4.

Continuing from step 450 of FIG. 4, responsive to determining that the outcomes are not consistent, the process forwards the request-for-approval to the employee-manager (step 510). Sometime thereafter, the process receives a response from the employee-manager (step 520). The process performs the human capital operation according to the response (step 530). The process can continue to process step 470 of FIG. 4 thereafter.

With reference next to FIG. 6, a flowchart of a process for performing the human capital operation according to inconsistent rule outcomes is depicted in accordance with an illustrative embodiment. The process in FIG. 6 can be implemented as an alternative to process step 430 of FIG. 4.

Continuing step from step 420 of FIG. 4, responsive to determining that the set of rules has not been configured, the process forwards the request-for-approval to the employee-manager (step 610). Sometime thereafter, the process receives a response from the employee-manager (step 620). The process performs human capital operation according to the response (step 630). The process can continue to process step 440 of FIG. 4 thereafter.

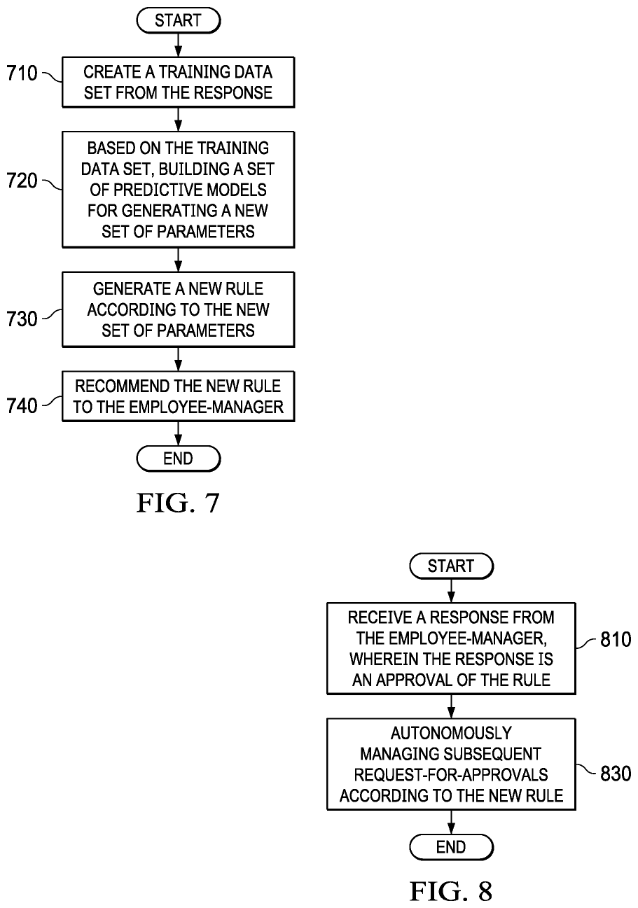

With reference next to FIG. 7, a flowchart of a process for performing the human capital operation according to inconsistent rule outcomes is depicted in accordance with an illustrative embodiment. The process in FIG. 7 can be implemented in conjunction with the process of FIG. 4.

The process creates a training data set from the response (step 710).

The process builds a set of predictive models, based on the training data set, for generating a new set of parameters (step 720). The process generates a new rule according to the new set of parameters (step 730). The process recommends the new rule to the employee-manager (step 740), and terminates thereafter.

With reference next to FIG. 8, a flowchart of a process for performing the human capital operation according to inconsistent rule outcomes is depicted in accordance with an illustrative embodiment. The process in FIG. 8 can be implemented in conjunction with the process of FIG. 4.

The process receives a response from the employee-manager, wherein the response is an approval of the new rule (step 810). The process autonomously manages subsequent request-for-approvals according to the new rule (step 830), and terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams can be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

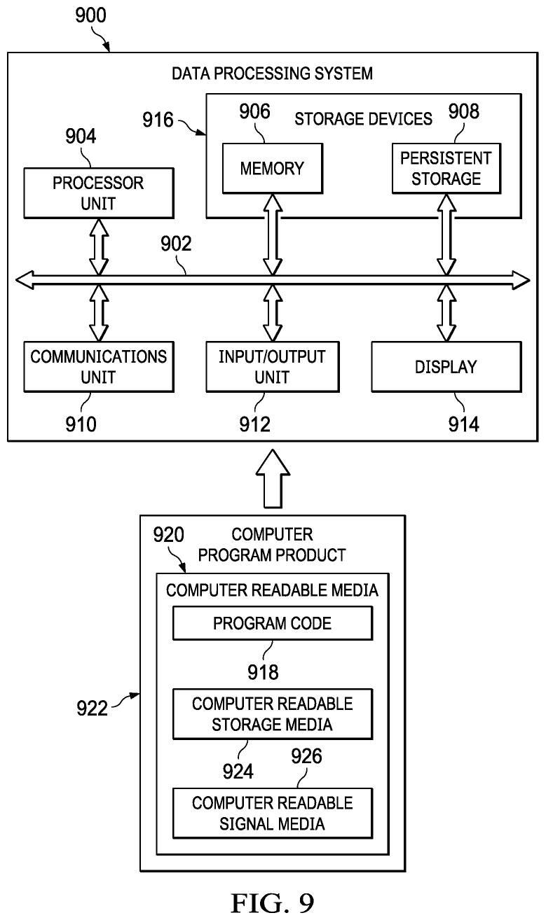

Turning now to FIG. 9, a block diagram of a data processing system is depicted in accordance with an illustrative embodiment. Data processing system 900 can be used to implement server computer 104, server computer 106, client devices 110, in FIG. 1. Data processing system 900 can also be used to implement computer system 214 in FIG. 2. In this illustrative example, data processing system 900 includes communications framework 902, which provides communications between processor unit 904, memory 906, persistent storage 908, communications unit 910, input/output (I/O) unit 912, and display 914. In this example, communications framework 902 takes the form of a bus system.

Processor unit 904 serves to execute instructions for software that can be loaded into memory 906. Processor unit 904 includes one or more processors. For example, processor unit 904 can be selected from at least one of a multicore processor, a central processing unit (CPU), a graphics processing unit (GPU), a physics processing unit (PPU), a digital signal processor (DSP), a network processor, or some other suitable type of processor. Further, processor unit 904 can may be implemented using one or more heterogeneous processor systems in which a main processor is present with secondary processors on a single chip. As another illustrative example, processor unit 904 can be a symmetric multi-processor system containing multiple processors of the same type on a single chip.

Memory 906 and persistent storage 908 are examples of storage devices 916. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 916 may also be referred to as computer-readable storage devices in these illustrative examples. Memory 906, in these examples, can be, for example, a random-access memory or any other suitable volatile or non-volatile storage device. Persistent storage 908 may take various forms, depending on the particular implementation.

For example, persistent storage 908 may contain one or more components or devices. For example, persistent storage 908 can be a hard drive, a solid-state drive (SSD), a flash memory, a rewritable optical disk, a rewritable magnetic tape, or some combination of the above. The media used by persistent storage 908 also can be removable. For example, a removable hard drive can be used for persistent storage 908.

Communications unit 910, in these illustrative examples, provides for communications with other data processing systems or devices. In these illustrative examples, communications unit 910 is a network interface card.

Input/output unit 912 allows for input and output of data with other devices that can be connected to data processing system 900. For example, input/output unit 912 may provide a connection for user input through at least one of a keyboard, a mouse, or some other suitable input device. Further, input/output unit 912 may send output to a printer. Display 914 provides a mechanism to display information to a user.

Instructions for at least one of the operating system, applications, or programs can be located in storage devices 916, which are in communication with processor unit 904 through communications framework 902. The processes of the different embodiments can be performed by processor unit 904 using computer-implemented instructions, which may be located in a memory, such as memory 906.

These instructions are program instructions and are also referred are referred to as program code, computer usable program code, or computer-readable program code that can be read and executed by a processor in processor unit 904. The program code in the different embodiments can be embodied on different physical or computer-readable storage media, such as memory 906 or persistent storage 908.

Program code 918 is located in a functional form on computer-readable media 920 that is selectively removable and can be loaded onto or transferred to data processing system 900 for execution by processor unit 904. Program code 918 and computer-readable media 920 form computer program product 922 in these illustrative examples. In the illustrative example, computer-readable media 920 is computer-readable storage media 924.

Computer-readable storage media 924 is a physical or tangible storage device used to store program code 918 rather than a medium that propagates or transmits program code 918. The term “non-transitory” or “tangible”, as used herein, is a limitation of the medium itself (i.e., tangible, not a signal) as opposed to a limitation on data storage persistency (e.g., RAM vs. ROM). Computer-readable storage media 924, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 918 can be transferred to data processing system 900 using a computer-readable signal media. The computer-readable signal media are signals and can be, for example, a propagated data signal containing program code 918. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media” can be singular or plural. For example, program code 918 can be located in computer-readable media 920 in the form of a single storage device or system. In another example, program code 918 can be located in computer-readable media 920 that is distributed in multiple data processing systems. In other words, some instructions in program code 918 can be located in one data processing system while other instructions in program code 918 can be located in one data processing system. For example, a portion of program code 918 can be located in computer-readable media 920 in a server computer while another portion of program code 918 can be located in computer-readable media 920 located in a set of client computers.

The different components illustrated for data processing system 900 are not meant to provide architectural limitations to the manner in which different embodiments can be implemented. In some illustrative examples, one or more of the components may be incorporated in or otherwise form a portion of, another component. For example, memory 906, or portions thereof, may be incorporated in processor unit 904 in some illustrative examples. The different illustrative embodiments can be implemented in a data processing system including components in addition to or in place of those illustrated for data processing system 900. Other components shown in FIG. 9 can be varied from the illustrative examples shown. The different embodiments can be implemented using any hardware device or system capable of running program code 918.

Thus, the illustrative embodiments of the present invention provide a computer-implemented method, computer system, and computer program product for autonomous management of request-for-approvals within an organization. The computer system receives a request-for-approval submitted by an employee of the organization. The computer system determines whether a set of rules has been configured for autonomously managing a human capital operation associated with the request-for-approval. Responsive to determining that the set of rules has been configured, the computer system determines whether a set of parameters for applying a particular rule has been met. Responsive to determining that the set of parameters for the particular rule has been met, the computer system applies the particular rule to determine an outcome. The computer system determines whether outcomes are consistent for each rule of the set of rules that was applied. Responsive to determining that the outcomes are consistent, the computer system autonomously performs the human capital operation according to the outcomes. Responsive to performing the human capital operation, the computer system transmits a confirmation of the human capital operation to an employee-manager.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer-implemented method for autonomous management of request-for-approvals within an organization, the computer-implemented method comprising:
receiving, by a computer system, a request-for-approval submitted by an employee of the organization;
determining, by the computer system, whether a set of rules has been configured for autonomously managing a human capital operation associated with the request-for-approval;
responsive to determining that the set of rules has been configured, determining, by the computer system, whether a set of parameters for applying a particular rule has been met;
responsive to determining that the set of parameters for the particular rule has been met, applying, by the computer system, the particular rule to determine an outcome;
determining, by the computer system, whether outcomes are consistent for each rule of the set of rules that was applied;
responsive to determining that the outcomes are consistent, autonomously performing, by the computer system, the human capital operation according to the outcomes; and
responsive to performing the human capital operation, transmitting, by the computer system, a confirmation of the human capital operation to an employee-manager.

2. The method of claim 1, wherein the human capital operation is selected from the group consisting of an approval of a time-off request, an approval of a timesheet, an approval of an expense, and combinations thereof.

3. The method of claim 2, wherein the set of parameters is selected from the group consisting of a classification of employees to whom the rule applies, a time period in which the rule applies, and combinations thereof.

4. The method of claim 3, wherein the human capital operation is the time-off request, and wherein the set of parameters includes additional parameters selected from the group consisting of team availability during the time-off period, duration of the time-off, a type of the time-off request, a nature of the time-off request, a projected workload during the time-off request, and combinations thereof.

5. The method of claim 3, wherein the human capital operation is the approval of the timesheet, and wherein the set of parameters includes additional parameters selected from the group consisting of total number of hours in the timesheet, total number of overtime hours in the timesheet, a historical variance of hours in the timesheet, a submission timeliness of the timesheet, and combinations thereof.

6. The method of claim 3, wherein the human capital operation is the approval of the expense, and wherein the set of parameters includes additional parameters selected from the group consisting of an amount of the expense, a type of the expense, a documentation of the expense, and combinations thereof.

7. The method of claim 1, further comprising:
responsive to determining that the outcomes are not consistent, forwarding, by the computer system, the request-for-approval to the employee-manager;
receiving, by the computer system, a response from the employee-manager; and
performing, by the computer system, the human capital operation according to the response.

8. The method of claim 1, further comprising:
responsive to determining that the set of rules has not been configured, forwarding, by the computer system, the request-for-approval to the employee-manager;
receiving, by the computer system, a response from the employee-manager; and
performing, by the computer system, the human capital operation according to the response.

9. The method of claim 8, further comprising:
creating a training data set from the response;
based on the training data set, building a set of predictive models for generating a new set of parameters;
generating a new rule according to the new set of parameters and
recommending, according to the set of predictive models, the new rule to the employee-manager.

10. The method of claim 9, further comprising:
receiving, by the computer system, a response from the employee-manager, wherein the response is an approval of the new rule; and
autonomously managing subsequent request-for-approvals according to the new rule.

11. A request management system for autonomous management of request-for-approvals within an organization, the request management system comprising:
a computer system; and
a request manager, wherein the request manager is configured:
to receive a request-for-approval submitted by an employee of the organization;
to determine whether a set of rules has been configured for autonomously managing a human capital operation associated with the request-for-approval;
responsive to determining that the set of rules has been configured, to determine a set of parameters for applying a particular rule has been met;
responsive to determining that the set of parameters for the particular rule has been met, to apply the particular rule to determine an outcome;
to determine whether outcomes are consistent for each rule of the set of rules that was applied;
responsive to determining that the outcomes are consistent, to autonomously perform the human capital operation according to the outcomes; and
responsive to performing the human capital operation, to transmit a confirmation of the human capital operation to an employee-manager.

12. The request management system of claim 11, wherein the human capital operation is selected from the group consisting of an approval of a time-off request, an approval of a timesheet, an approval of an expense, and combinations thereof.

13. The request management system of claim 12, wherein the set of parameters is selected from the group consisting of a classification of employees to whom the rule applies, a time period in which the rule applies, and combinations thereof.

14. The request management system of claim 13, wherein the human capital operation is the time-off request, and wherein the set of parameters includes additional parameters selected from the group consisting of team availability during the time-off period, duration of the time-off, a type of the time-off request, a nature of the time-off request, a projected workload during the time-off request, and combinations thereof.

15. The request management system of claim 13, wherein the human capital operation is the approval of the timesheet, and wherein the set of parameters includes additional parameters selected from the group consisting of total number of hours in the timesheet, total number of overtime hours in the timesheet, a historical variance of hours in the timesheet, a submission timeliness of the timesheet, and combinations thereof.

16. The request management system of claim 13, wherein the human capital operation is the approval of the expense, and wherein the set of parameters includes additional parameters selected from the group consisting of an amount of the expense, a type of the expense, a documentation of the expense, and combinations thereof.

17. The request management system of claim 11, wherein the request manager is further configured:
responsive to determining that the outcomes are not consistent, to forward the request-for-approval to the employee-manager;
to receive a response from the employee-manager; and
to perform the human capital operation according to the response.

18. The request management system of claim 11, wherein the request manager is further configured:
responsive to determining that the set of rules has not been configured, to forward the request-for-approval to the employee-manager;
to receive a response from the employee-manager; and
to perform the human capital operation according to the response.

19. The request management system of claim 18, wherein the request manager is further configured:
to create a training data set from the response;
based on the training data set, to build a set of predictive models for generating a new set of parameters;
to generate a new rule according to the new set of parameters and
to recommend, according to the set of predictive models, the new rule to the employee-manager.

20. The request management system of claim 19, wherein the request manager is further configured:
to receive a response from the employee-manager, wherein the response is an approval of the new rule; and
to autonomously manage subsequent request-for-approvals according to the new rule.

21. A computer program product for autonomous management of request-for-approvals within an organization, the computer program product comprising:
a computer-readable storage media;
program code, stored on the computer-readable storage media, executable by a computer system to for, the computer-implemented method comprising:
program code for receiving a request-for-approval submitted by an employee of the organization;
program code for determining whether a set of rules has been configured for autonomously managing a human capital operation associated with the request-for-approval;
program code for determining, responsive to determining that the set of rules has been configured, whether a set of parameters for applying a particular rule has been met;
program code for applying, responsive to determining that the set of parameters for the particular rule has been met, the particular rule to determine an outcome;
program code for determining whether outcomes are consistent for each rule of the set of rules that was applied;
program code for autonomously performing, responsive to determining that the outcomes are consistent, the human capital operation according to the outcomes; and
program code for transmitting, responsive to performing the human capital operation, a confirmation of the human capital operation to an employee-manager.

22. The computer program product of claim 21, wherein the human capital operation is selected from the group consisting of an approval of a time-off request, an approval of a timesheet, an approval of an expense, and combinations thereof.

23. The computer program product of claim 22, wherein the set of parameters is selected from the group consisting of a classification of employees to whom the rule applies, a time period in which the rule applies, and combinations thereof.

24. The computer program product of claim 23, wherein the human capital operation is the time-off request, and wherein the set of parameters includes additional parameters selected from the group consisting of team availability during the time-off period, duration of the time-off, a type of the time-off request, a nature of the time-off request, a projected workload during the time-off request, and combinations thereof.

25. The computer program product of claim 23, wherein the human capital operation is the approval of the timesheet, and wherein the set of parameters includes additional parameters selected from the group consisting of total number of hours in the timesheet, total number of overtime hours in the timesheet, a historical variance of hours in the timesheet, a submission timeliness of the timesheet, and combinations thereof.

26. The computer program product of claim 23, wherein the human capital operation is the approval of the expense, and wherein the set of parameters includes additional parameters selected from the group consisting of an amount of the expense, a type of the expense, a documentation of the expense, and combinations thereof.

27. The computer program product of claim 21, wherein the program code further comprises:
program code for forwarding, responsive to determining that the outcomes are not consistent, the request-for-approval to the employee-manager;
program code for receiving a response from the employee-manager; and
program code for performing the human capital operation according to the response.

28. The computer program product of claim 21, wherein the program code further comprises:
program code for forwarding, responsive to determining that the set of rules has not been configured, the request-for-approval to the employee-manager;
program code for receiving a response from the employee-manager; and
program code for performing the human capital operation according to the response.

29. The computer program product of claim 28, wherein the program code further comprises:
program code for creating a training data set from the response;
program code for building, based on the training data set, a set of predictive models for generating a new set of parameters;
program code for generating a new rule according to the new set of parameters and
program code for recommending, according to the set of predictive models, the new rule to the employee-manager.

30. The computer program product of claim 29, wherein the program code further comprises:
program code for receiving a response from the employee-manager, wherein the response is an approval of the new rule; and
program code for autonomously managing subsequent request-for-approvals according to the new rule.
